(19) United States
(12) Patent Application Publication
(10) Pub. No.: US 2026/0229954 A1
(43) Pub. Date: Aug. 6, 2026

(54) APPARATUS HAVING AT LEAST ONE ACTUATOR DEVICE FOR PRECISELY INFLUENCING THE MOVABILITY OF A TRANSMISSION ELEMENT

(71) Applicant: INVENTUS ENGINEERING GMBH, St. Anton i.M. (AT)

(72) Inventors: Stefan BATTLOGG, St. Anton i.M. (AT); Philipp DÖNZ, Silbertal (AT)

(21) Appl. No.: 19/150,628

(22) PCT Filed: Jan. 22, 2024
(86) PCT No.: PCT/EP2024/051387

§ 371 Date: Jul. 24, 2025

(30) Foreign Application Priority Data
Jan. 24, 2023 (DE) 10 2023 101 620.2
Feb. 22, 2023 (DE) 10 2023 104 340.4
Dec. 5, 2023 (DE) 10 2023 134 018.2
Dec. 13, 2023 (DE) 10 2023 134 989.9

(51) Int. Cl. H02K 7/102; B62D 6/00; E05F 3/00; G05G 5/03; H02K 7/08; H02K 21/24

(52) U.S. Cl. CPC H02K 7/1023; B62D 6/008; E05F 3/00; G05G 5/03; H02K 7/083; H02K 21/24; E05Y 2201/21; E05Y 2900/132; G05G 2505/00; H02K 2213/06; H02K 2213/09

(57) ABSTRACT

A device having a movable transmission element and an actuator for influencing the mobility of the transmission element. The actuator has a magnetorheological brake for producing a braking torque which acts on the transmission element and a drive for producing a torque which acts on the transmission element. The brake and the drive are arranged adjacent to one another on a common receiving structure.

The invention relates to a device which comprises at least one movable transmission element and at least one actuator device for specifically influencing the mobility of the transmission element. The actuator device comprises at least one magnetorheological braking device for generating a braking torque acting on the transmission element, so that the mobility of the transmission element can be specifically braked. The actuator device also comprises at least one drive device for generating a torque acting on the transmission element, so that the transmission element can be actively moved.

Such a device can be an operating device which is designed, for example, as a steering input device according to the steer-by-wire concept (SbW, steer-by-wire). The operating device can then be equipped with an actuator device known as a “force feedback actuator” (FFA). The FFA comprises, for example, an (electric) motor and a continuously adjustable braking device based on the magnetorheological principle. In steering systems based on the steer-by-wire concept, the steering command recorded by the steering input (by manually turning the steering input device) is electronically transmitted to a so-called road wheel actuator (RWA, vehicle wheel actuator), which adjusts the steering angle of the wheels in accordance with the steering command.

The SbW concept generally requires high passive torques (10-35 Nm), against which the steering wheel must be manually turned (e.g., for end stops). At the same time, particularly low (active) torques (0.5-5 Nm) are required, which trigger the return of the steering wheel and generate haptic signals or force feedback. For example, such feedback simulates the movements that emanate from the chassis in conventional steering systems and are felt on the steering wheel.

In the current state of the art, SbW systems usually have only one electric motor that generates both the active and passive torques, e.g. for an end stop. An electric motor requires high currents to generate high passive torques and the motor must be larger than for the necessary active torques.

These motors heat up considerably, which leads to thermal problems. The high currents are also detrimental to the vehicle's energy management. In addition, electronic components must be selected that are suitable for the high electrical loads (currents). These are also expensive to purchase. In addition, the correspondingly large motors usually have a gear stage (e.g. worm gear, belt gear). However, the additional components increase the installation space required, the weight and also the costs, not insignificantly.

Actuators with magnetorheological fluid (MRF actuators or MRF brakes) usually require only a small amount of current for passive torque and require less space than electric motors. However, they cannot generate active power. A combination of the two is therefore recommended. However, the steering sometimes feels a bit spongy or imprecise because the MRF actuator and motor have a certain amount of gear play in relation to each other.

High torques or braking torques generally require correspondingly large motors or brakes. This disadvantageously increases the base torque (also known as the idling torque). However, a high base torque is very much at odds with the requirement for smooth steering and good controllability. Vehicles with self-driving systems and optional autonomous driving should also have foldable/retractable steering wheels. Such self-driving systems must necessarily be compact and lightweight. The solutions known to date therefore require a great deal of improvement.

For other types of control devices, such as joysticks, the precision of the haptic signals or force feedback, the space requirements, energy consumption, and weight generally play an important role. These aspects are also crucial for other applications of the device, such as exoskeletons, prostheses, or door systems.

In contrast, the object of the present invention is to provide an improved device. In particular, the device should meet the previously discussed requirements as far as possible and preferably at the same time offer a reliable and safe function and be economically producible.

This object is achieved by a device having the features of claim 1. Preferred developments of the invention are the subject of the subclaims. Further advantages and features of the present invention emerge from the general description and from the description of the exemplary embodiments.

The device according to the invention comprises at least one actuator device for the targeted influencing of the mobility of a (movable) transmission element. The device comprises in particular at least one movable transmission element. The device comprises at least one actuator device for the targeted influencing of the mobility of the transmission element. The actuator device comprises at least one magnetorheological braking device for generating a braking torque which acts on the transmission element.

The mobility of the transmission element can be braked in a targeted manner. The actuator device comprises at least one drive device for generating a torque which acts on the transmission element. The transmission element can be actively moved by means of the drive device. The braking 8 device and the drive device are arranged adjacent to one another on or in a common receiving structure. In particular, the (entire) actuator device is attached to the receiving structure. In particular, the actuator device or the device can be referred to as a force feedback actuator (FFA).

The device according to the invention offers many advantages. A significant advantage is the arrangement of the braking device and drive device on the common support structure. This enables a particularly compact and at the same time structurally uncomplicated device. With such a device, the previously discussed requirements can be met reliably, inexpensively and economically. The requirements are met particularly advantageously when used as an operating device or steering control device. With the invention, particularly low basic torques can be achieved.

Preferably, the receiving structure comprises at least one housing device or is designed as such. Preferably, the drive device and the braking device are housed together (integrated) in the housing device and in particular also fastened. In particular, the housing device comprises at least one housing or is designed as such. In particular, the drive device and the braking device and at least partially (to a large extent) also the shaft device are housed within a housing space of the housing device.

The housing device serves in particular to house at least one of the following components: at least one (preferably both) of the drive components, the motor coil, at least one (preferably both) of the braking components, the effective gap, the magnetorheological medium, the coil device of the braking device, the shaft device.

In an advantageous further development, the receiving structure connects the drive device and the braking device to form a pre-assembly. In particular, the pre-assembly can be handled as a unit. The pre-assembly can, for example, be mounted as a unit in a vehicle or another device that is to be controlled or steered by means of the device or operating device.

Preferably, the drive device and the braking device are arranged axially (or in the axial direction of the shaft device) one behind the other. In particular, the drive device and the braking device are coupled to one another in sections (in contact).

It is also possible and preferred that the drive device and the brake device are arranged coaxially at least in sections. In particular, the brake device and the drive device are arranged at least partially nested in the radial direction of the shaft device. In particular, one of the brake components that can be rotated relative to one another is arranged in a rotationally fixed manner on one of the drive components that can be rotated relative to one another. In particular, the brake component is arranged radially on the outside and the drive component is arranged radially on the inside. It is also possible that the brake component is arranged radially on the inside and the drive component is arranged radially on the outside.

The device comprises in particular at least one shaft device. The shaft device is in particular designed as a shaft or comprises at least one such shaft. In particular, the shaft device and the receiving structure are arranged to be rotatable relative to one another and are preferably rotatable. mounted on one another. In particular, the drive 6 device and/or the braking device are connected to the shaft device and in particular also to the transmission element 8 in the manner of a direct drive. In particular, a relative movement between the shaft device and the receiving structure can be driven by means of the drive device and braked by means of the braking device.

The shaft device and the receiving structure are mounted on one another in particular by means of at least one bearing device. In particular, the bearing device is arranged between the shaft device and the receiving structure. When, within the scope of the present invention, the shaft device is mounted on the receiving structure, the shaft device can be rotatable and the receiving structure can be stationary.

However, it is also possible for the receiving structure to be rotatable and the shaft device to be stationary.

In particular, the shaft device is coupled (in a rotationally fixed manner) to the transmission element. In particular, the shaft device and the transmission element are coupled in such a way that they can (only) be rotated together, while the receiving structure is preferably stationary. The shaft device and the transmission element can be designed separately or connected to one another in one piece. For example, the transmission element is a section of the shaft device. In particular, the receiving structure is designed to be stationary. In particular, the receiving structure is connected (in a rotationally fixed manner) to a stationary support structure, for example a body structure of a vehicle. In particular, a movement of the transmission element can be transferred to the shaft device and vice versa.

It is also possible that the receiving structure is coupled (rotatably) to the transmission element. In particular, the receiving structure and the transmission element are coupled in such a way that that they can (only) be rotated together, while the shaft device is stationary. The 8 transmission element can be designed separately or connected in one piece to the receiving structure. In particular, the shaft device is designed to be stationary.

In particular, the shaft device is connected (in a rotationally fixed manner) to a stationary support structure, for example a body structure of a vehicle. In particular, a movement of the transmission element can be transferred to the receiving structure and vice versa. In such an embodiment, the shaft device can also be referred to as an axle.

In particular, the drive device and the braking device act without an intermediate gear and preferably directly on the shaft device. In particular, the shaft device forms a common shaft (or axis) for the drive device and the braking device, and preferably also for the transmission element.

In particular, the transmission element and the drive device and the braking device are rotatably mounted on the receiving structure exclusively by means of the shaft device. In particular, the shaft device is the only component of the device that is rotatably mounted on the receiving structure (by means of at least one bearing device). The drive device and the braking device, and in particular also the transmission element, are preferably rotatably mounted on the receiving structure only by being (rotatably) attached to the shaft device. Such an embodiment can be implemented both with a fixed shaft device and with a fixed receiving structure.

In particular, the shaft device is connected without an intermediate gear and preferably directly to the transmission element. It is also possible that the receiving structure is connected without an intermediate gear and preferably directly to the transmission element.

The shaft device or the receiving structure can be firmly and in particular integrally connected to the transmission element. However, it is also possible for the transmission element to be designed as a separate component which is connected in a rotationally fixed manner to the shaft device or the receiving structure.

Alternatively, the shaft device could be connected to the transmission element via a gear. Preferably, a ratio of e.g. 1:5 is then provided between the transmission element and the drive device and the braking device. This means that the size of the drive device or braking device can be selected to be smaller.

The drive device comprises in particular at least two drive components that can be rotated relative to one another. In particular, at least one first drive component and at least one second drive component that can be rotated relative to the first drive component are provided. In particular, the drive components that can be rotated relative to one another comprise at least one drive stator and at least one drive rotor.

In particular, the braking device comprises at least two braking components that can be rotated relative to one another. In particular, at least one first braking component and at least one second braking component that can be rotated relative to the first braking component are provided. For example, at least one braking stator and at least one braking rotor are provided.

It is preferred and advantageous that the shaft device is connected in a rotationally fixed manner to one (first) of the at least two drive components that are rotatable relative to one another. It is also preferred and advantageous that the shaft device is connected in a rotationally fixed manner to one (first) of the at least two brake components that are rotatable relative to one another. In particular, the (first) drive component and/or the (first) brake component is connected without an intermediate gear and preferably directly to the shaft device. The (first) drive component and/or the (first) brake component can be integrally connected to the shaft device. In particular, the shaft device can only be rotated together with the first drive component and/or the first brake component.

It is preferred and advantageous that the receiving structure is connected in a rotationally fixed manner to a (second) of the at least two drive components that can rotate relative to one another. It is also preferred and advantageous that the receiving structure is connected in a rotationally fixed manner to a (second) of the at least two brake components that can rotate relative to one another.

In particular, the (second) drive component and/or the (second) brake component is connected without an intermediate gear and preferably directly to the receiving structure. The (second) drive component and/or the (second) brake component can be connected in one piece to the receiving structure. In particular, the receiving structure can only be rotated together with the second drive component and/or the second brake component.

The shaft device and the receiving structure are in particular rotatably mounted to one another by means of at least one bearing device. In particular, the bearing device comprises at least two and preferably only two bearing points. In particular, the drive components of the drive device, which can rotate relative to one another, and the brake components of the brake device, which can rotate relative to one another, are mounted exclusively by the bearing device. In particular, no further bearing points are provided for the mounting of the drive components and/or the brake components in addition to this bearing device. However, an embodiment is also possible in which the drive components and/or the brake components are rotatably mounted relative to one another by means of at least one additional bearing point. The bearing points comprise in particular at least one bearing and, for example, a rolling bearing or plain bearing or the like.

In particular, at least one of the drive component connected to the shaft device and the at least one brake component connected in a rotationally fixed manner to the shaft device are (exclusively) mounted together on the receiving structure via the bearing device of the shaft device. In particular, the at least one drive component which is not connected in a rotationally fixed manner to the shaft device and/or the at least one brake component which is not connected in a rotationally fixed manner to the shaft device are rotationally fastened to such a supporting structure on which the shaft device is also rotatably mounted. In particular, this supporting structure is the receiving structure. In particular, the at least one drive component which is not connected in a rotationally fixed manner to the shaft device and/or the at least one brake component which is not connected in a rotationally fixed manner to the shaft device are (rotationally fixed) fastened to the receiving structure.

It is possible that a (first) of the brake components that can rotate relative to one another is connected to a (first) of the drive components that can rotate relative to one another. In particular, the brake component is connected to the drive component by means of the shaft device. It is possible that this brake component is connected in one piece to the drive component and in particular also to the shaft device. For example, the shaft device and the brake component and the drive component form a one-piece component.

In an advantageous development, an electrical connection of the drive device and/or an electrical connection of the braking device is made (only) via the receiving structure and/or (only) via the shaft device. In particular, the electrical connection runs through the receiving structure.

In particular, the components of the drive device and/or the braking device, which must be supplied with energy or controlled via the electrical connection, are arranged on the fixed receiving structure. If the shaft device is designed to be stationary, these components are arranged in particular on the shaft device. The electrical connection is then made, in particular, via the shaft device. In particular, the electrical connection runs through the shaft device.

The electrical connection can also be made via the non-fixed component (support structure or shaft device). In this case, for example, coil springs or sliding contacts or the like are provided.

The electrical connection is intended in particular for the coil device of the braking device and/or for the motor coil(s) of the drive device. The electrical connection can also be used for a sensor device.

In a particularly advantageous development, the drive component that is connected to the shaft device in a rotationally fixed manner at least partially provides the brake component that is connected to the shaft device in a rotationally fixed manner. This enables component integration that saves considerable installation space, weight and design effort. In particular, the drive component that is connected to the shaft device in a rotationally fixed manner and the brake component that is connected to the shaft device in a rotationally fixed manner share at least one common component. In particular, this component is designed to be magnetically conductive.

In particular, a magnetic field flows through this component when the actuator device is in operation and is preferably a component of a magnetic circuit.

It is advantageous and preferred that the drive component, which is connected in a rotationally fixed manner to the receiving structure, at least partially provides the brake component, which is connected in a rotationally fixed manner to the receiving structure. This also enables particularly advantageous component integration. In particular, the drive component, which is connected in a rotationally fixed manner to the receiving structure, and the brake component, which is connected in a rotationally fixed manner to the receiving structure, share at least one common component. In particular, this component is designed to be magnetically conductive. In particular, a magnetic field flows through this component during operation of the actuator device and is preferably a component of a magnetic circuit. In particular, the drive component, which is connected in a rotationally fixed manner to the receiving structure, contacts the brake component, which is connected in a rotationally fixed manner to the receiving structure.

In particular, the drive component, which is connected in a rotationally fixed manner to the receiving structure, and the brake component, which is connected in a rotationally fixed manner to the receiving structure, are directly connected to one another, in particular by contact.

The drive device preferably comprises at least one electric motor or is designed as such. In particular, the electric motor is designed as an axial flux motor and preferably as a disk rotor. It is possible for the electric motor to be designed as a bell-armature motor. In particular, the electric motor is shorter in the axial direction than in the radial direction or in diameter. Such electric motors are particularly suitable for integration in the common receiving structure. The axial flux motor offers many advantages, but it also requires a special arrangement of the components and a special design (e.g. disk-shaped instead of cylindrical, axial length). In addition, it shows different behavior at certain speeds. With the invention presented here, the axial flux motor and its advantages can be particularly well integrated and utilized structurally.

Other suitable motor types are also possible, such as a radial flux motor (in particular an external rotor motor or an internal rotor motor) or a travelling wave motor or an ultrasonic motor or a combination of the motor types presented here. Preferably, the drive device can generate the torque itself (without, for example, a spring having to be tensioned beforehand). The electric motor can only have a single motor coil winding. This means that any redundancy requirements are met by a simple electric motor with a motor coil winding in combination with a braking device (=so-called hybrid redundancy). Alternatively, it is also possible for the electric motor to have two or more independent motor coil windings that are connected to different control devices or energy supplies. If one of the energy supplies or one of the control devices or one of the coil windings fails, the other of the coil windings is still able to generate a torque by supplying the appropriate current using the independent energy supply.

It is possible for the drive device to comprise at least one mechanical energy storage device or to be designed as such. In particular, the energy storage device can be charged by moving the transmission element. In particular, the transmission element can be set in motion by the energy stored in the energy storage device. In particular, the energy storage device is accommodated in the receiving structure.

In particular, the energy storage device serves to return the transmission element from a deflected position to a rest position. The movement of the transmission element generated or supported by the energy storage device and/or the (rest) position of the transmission element can preferably be influenced in a targeted manner using the braking device. For example, a spring characteristic curve of the energy storage device can be adjusted using the braking device. The energy storage device can be used to apply a targeted torque to the mobility of the transmission element in the event of a fault.

The energy storage device comprises in particular at least one (mechanical) spring. All types of suitable mechanical springs are possible (torsion spring, spiral spring, leg spring, etc.). It is possible that the energy storage 4 device electric motor of the drive device. It is also possible that the energy storage device alone provides the torque for the movement of the transmission element. In particular, the drive device then has no electric motor or the like.

Such a force storage device is particularly advantageous in a steer-by-wire steering system when, for example, a spring with a low maximum force and a low force increase over the angle of rotation can be used, so that the sum of spring force (spring torque) and base torque or base friction at full deflection does not exceed the permissible (low value) for such a steering system, while still allowing for rapid return. The invention presented here makes particularly good use of these advantages.

In particular, an (air) gap between the drive components that can rotate relative to one another runs in the radial direction and/or transversely to a rotation axis of the drive components that can rotate relative to one another or to the rotation axis of the shaft device. In particular, the magnetic field of the electric motor runs at least in the gap between the at least two drive components that can rotate relative to one another parallel to the rotation axis of the drive components that can rotate relative to one another or to the rotation axis of the shaft device.

It is possible for the electric motor to have at least two (disk-shaped) stators and at least one rotor in between. It is also possible for the electric motor to have only one (disk-shaped) stator, which is located axially next to the rotor. In particular, the drive components provide the stator and the rotor. The electric motor can be designed in particular as an internal rotor (rotor inside, stator outside) or as an external rotor (rotor outside, stator inside). The braking device can be designed in particular as an internal rotor (fixed brake component inside, rotatable brake component outside) or as an external rotor (fixed brake component outside, rotating brake component inside).

Preferably, at least one circumferential gap (so-called effective gap) is formed between the brake components that can rotate relative to one another. In particular, the gap is at least partially filled with a magnetorheological medium. In particular, the medium arranged in the gap can be influenced by means of the coil device in such a way that the relative mobility of the brake components can be braked in a targeted manner.

In particular, the gap has a variable gap height in the circumferential direction at least in sections, preferably at least in the (magnetorheologically effective) gap sections. In particular, one of the brake components that can rotate relative to one another has an outer contour with a variable outer diameter and in particular a star contour. The star contour in particular has a plurality of magnetic field concentrators that protrude in the radial direction.

The gap of the braking device preferably has at least two circumferential gap sections arranged at a distance from one another. In particular, the gap sections differ in their minimum and/or maximum diameter. In particular, the gap sections are connected to one another via a circumferential connecting gap. Overall, the gap therefore provides a circumferential, continuous receiving space for the medium.

The magnetorheological braking effect is provided in particular by the gap sections. In particular, the maximum gap height in the area of the gap sections is lower than in the remaining area of the gap and in particular in the connecting gap.

In particular, the gap sections are located at different radial positions (or diameter positions). In particular, one gap section is radially further inward and another gap section is radially further outward. In particular, the gap is stepped. In particular, the gap sections are located at different levels. In particular, at least one of the brake components has at least two circumferential step sections.

The step sections have in particular different diameters.

In an advantageous development, at least one of the brake components which can rotate relative to one another, in particular the brake component which is stationary during operation, provides at least one receiving space for a winding of an electrical coil device. In particular, a base wall runs between the receiving space and the gap (in particular the connecting gap). In particular, the base wall has a thickness which is less than a maximum height (cross-sectional height) of the gap running beneath the base wall. As a result, the base wall can be made from a magnetically conductive material without a magnetic short circuit occurring beneath the receiving space. In particular, the base wall is an integral part of the brake component. In particular, the base wall hermetically separates the coil device from the medium located in the gap.

In particular, the brake component which has the receiving space comprises at least two effective gap walls. In particular, the effective gap walls are each arranged axially next to the base wall. In particular, one of the two effective gap walls extends further radially inwards than the base wall. In particular, the base wall extends further radially inwards than the other of the two effective gap walls. In particular, the effective gap walls each delimit a gap section radially outwards. In particular, one of the effective gap walls delimits the receiving space axially outwards.

It is preferred and advantageous that the bottom wall and the active gap walls and a section of the receiving structure are connected to one another in one piece. In particular, the bottom wall and the active gap walls and the section together a predominant part of the brake component or even the entire brake component. In particular, at least this part or also the brake component is made of a magnetically conductive material. In particular, the entire brake component is formed in one piece.

Preferably, the base wall and the active gap walls and the section form a rotationally symmetrical (one-piece) turned part. The turned part can be produced in particular by turning. Further processing after turning is possible.

However, additive manufacturing (3D printing) is also possible. The brake component can be designed as such a turned part or at least comprise such a part. In particular, at least the turned part is made of a magnetically conductive material.

The bottom wall can also be omitted so that the coil (or the coil holder, if present) is in direct contact with the medium.

It is preferred and advantageous that the shaft device is mounted on the partial section. In particular, the partial section serves to attach a bearing point (the bearing device). The shaft device can be designed to be rotatable or fixed.

In an advantageous development, the receiving space is at least partially closed radially outward by a cover section of the receiving structure. In particular, the section is designed as a housing cover. This enables simple assembly of the brake components and drive components inside the receiving structure.

In a preferred and advantageous embodiment, it is provided that one of the brake components that can rotate relative to one another, preferably the brake component that is stationary during operation, has at least one base section and at least one outer magnetic flux flange. The base section, in particular, has at least one receiving space that is open axially outward for an electrical coil device (in particular its winding). The outer magnetic flux flange is arranged both axially and radially between the coil device and the base section.

Preferably, the outer magnetic flux flange is also designed to be open axially outward. In particular, the base section is connected to the receiving structure. In particular, the shaft device is mounted on the base section (by means of one of the bearing points of the bearing device).

In particular, the outer magnetic flux flange has a higher magnetic conductivity than the base section.

In particular, the coil device has at least one winding and at least one coil holder for receiving the winding. In particular, the coil holder is attached to the outer magnetic flux flange.

In particular, the receiving space and the (effective) gap are not sealed from one another. In particular, the coil device is not separated from the medium in the gap by other components and in particular not by magnetically conductive components. In particular, the winding and in particular also the coil holder are located within the gap. It is possible that the coil holder has contact with the medium.

It is preferred and advantageous that the outer magnetic flux flange has at least two legs. Preferably, one leg delimits a gap section of the (effective) gap radially outward. In particular, the legs are arranged in an L-shape relative to one another. In particular, the legs meet one another. In particular, the legs are connected to one another in one piece. In particular, one leg runs essentially radially and one leg runs essentially axially.

Preferably, one of the relatively rotatable brake components has at least one rotor section and at least an inner magnetic flux flange. In particular, it is the brake component that does not have the outer magnetic flux flange. In particular, the rotor section is connected to the shaft device or to the receiving structure in a rotationally fixed manner and in particular in one piece. The magnetic flux flange preferably has at least two legs. In particular, one leg delimits a gap section of the gap radially inward. In particular, the legs are arranged in an L-shape relative to one another. In particular, the legs are connected to one another in one piece. In particular, one leg runs essentially radially and the other leg runs essentially axially.

Preferably, the rotor section and the inner magnetic flux flange are formed separately. In particular, the rotor section and the inner magnetic flux flange are firmly connected to one another. For example, they are two separate components which are firmly joined to one another.

In particular, the inner magnetic flux flange has a higher magnetic conductivity than the rotor section.

It is also possible that the rotor section and the inner magnetic flux flange are connected to one another in one piece. The rotor section and the inner magnetic flux flange then have the same magnetic conductivity.

In an advantageous embodiment, it is provided that the receiving structure (in particular at least one structural section of the receiving structure) and one of the at least two brake components that can be rotated relative to one another are connected to one another in one piece. In particular, the receiving structure (preferably the structural section) and the brake component together form a structural component. It is preferred that the shaft device is mounted on the structural component. In particular, the mounting takes place by means of at least one bearing point of the bearing device. The brake component, which is part of the structural component, is in particular not rotatable relative to the receiving structure or is non-rotatably connected to the receiving structure.

The structural component preferably supports at least one bearing point of the bearing device for the shaft device.

The structural component is in particular a load-bearing component of the receiving structure. In particular, the structural component is suitable and designed to absorb at least part of the bearing forces of the bearing device. For example, the structural component is a load-bearing wall of the housing device.

The drive device and the braking device preferably use at least one of the following components together: shaft device, bearing device for supporting the drive components that can rotate relative to one another and the braking components that can rotate relative to one another, sealing device, torque support, electrical connection.

In an advantageous development, the device comprises at least one failure protection device which is suitable and designed to apply a targeted torque (or braking torque) to the mobility of the transmission element at least in the event of a failure of the braking device and/or a failure of the drive device. As a result, the transmission element is neither blocked nor can it be moved without resistance.

This is particularly advantageous when designed as an operating device or steering control device.

The failure protection device comprises in particular at least one permanent magnet device, the magnetic field of which slows down the mobility of the brake components with a defined torque. In particular, the magnetic field of the permanent magnet device can be reduced and/or increased during normal operation by an electrical coil device. The coil device of the fault protection device is in particular the coil device of the brake device, which serves to generate the braking torque during normal operation. The fault protection device can also be a have their own coil device. It is possible that the magnetic field of the permanent magnet device is used in normal operation to support the braking effect.

A maximum braking torque of the braking device is in particular greater and preferably greater by a factor of two than a maximum torque of the drive device. It is also possible and advantageous for the maximum braking torque of the braking device to be greater by a factor of three or four or five or six than a maximum torque of the drive device. In particular, the braking device serves to block a steering unit in such a way that it serves as an exit aid from a vehicle.

In particular, the actuator device provides at least one end stop for the mobility of the transmission element. In particular, this can limit rotation (at least at one defined angular position) in at least one and preferably in both directions of rotation. It is possible for a braking torque to be generated by means of the braking device, which provides the end stop. Additionally or alternatively, at least one mechanical end stop can be provided. This can possibly make the maximum braking torque of the braking device lower.

In all embodiments, it is particularly preferred that the mobility of the transmission element can be specifically influenced by means of the braking device (preferably also with the drive device), so that haptically perceptible feedback or signals (so-called force feedback) can be generated on the transmission element. In particular, the feedback can be generated while the transmission element is moved at least partially by muscle power and/or at least partially by the drive device. For example, the mobility of the transmission element during an input (in particular during a manual movement of the transmission element) can be influenced by means of the braking device (preferably the haptic feedback can be specifically influenced by the motion sensor (also with the drive device). It can be provided that the haptic feedback is generated while the transmission element is stationary or is not being moved by muscle power. In particular, the drive device can also generate the haptic signals when the transmission element is stationary. For example, grids, blockages, vibrations and/or end points on the transmission element can be felt as haptic feedback.

In particular, the drive device serves to move the transmission element against the force of a manual movement and/or to return the transmission element during and/or after a manual movement. In this case, haptically perceptible feedback (in particular by means of the braking device) can preferably be generated at the same time.

The transmission element can be actively moved in particular by the actuator device (the drive device). The transmission element can be moved in particular (also) manually. In the context of the present invention, manual mobility is understood to mean mobility that is at least partially caused by muscle power. The movement can be caused not only by the hands, but also by other muscle-coupled body structures (arms, legs, feet, back, torso, stomach, head, jaw, etc.). The transmission element can be designed, for example, as a lever or a shaft or the like.

In an advantageous development, the device presented here is designed as an operating device, which is provided in particular for the (manual) specification of a control command. The terms “device” and “operating device” can then be used synonymously. The transmission element is then in particular an operating element. In particular, the operating element can be moved at least during an input (in particular during a manual movement of the control element) can be specifically influenced by means of the braking device (preferably also with the drive device).

The device or operating device is particularly preferably designed as a steering specification device for specifying a steering command according to the steer-by-wire concept.

The transmission element or operating element is then preferably designed as a steering unit or at least comprises such a unit. In the context of such a steering specification device, the term “operating element” can then preferably be replaced by the term “steering unit”. The applicant reserves the right to claim such a steering specification device. The steering unit can be, for example, a steering wheel or a control wheel or a joystick.

In one embodiment as a steering specification device, the shaft device is in particular designed as a steering shaft or at least comprises such a shaft. In particular, the steering shaft is rotatably mounted on the receiving structure. In particular, the steering unit is then connected to the steering shaft in a rotationally fixed manner. In particular, the receiving structure is attached to a support structure of the vehicle. However, it is also possible for the steering shaft to be fixed (in principle an axle) to a support structure of the vehicle. In this case, the receiving structure is preferably rotatably mounted on the steering shaft. In particular, the steering unit is then connected to the receiving structure in a rotationally fixed manner. In particular, the steering unit is then rotatable relative to the steering shaft.

It is possible and advantageous that the receiving structure is mounted directly on the operating element and in particular on the steering unit (in a rotationally fixed manner). It is also possible and advantageous that the shaft device is mounted directly (in a rotationally fixed manner) on the operating element, in particular on the steering unit, and has a length which is not greater than 2.5 times the axial extension of the receiving structure and/or actuator device. In other words, in the invention, the support structure can essentially be arranged in the immediate vicinity of the steering unit and a steering column as such is not necessary.

In particular, the support structure (or its covering) installed in the vehicle as intended is visible from the vehicle seats. In particular, the support structure is housed in a housing of the steering unit or is part of such a housing. In particular, the support structure and the steering unit are arranged outside a dashboard. However, it is also possible that the support structure is connected to the control element or the steering unit by means of a conventional (longer) steering shaft or steering column.

The support structure and the steering unit can form a pre-assembly which can be handled as a unit. In particular, the support structure and the steering unit can be installed as a unit in a vehicle.

It can be provided that the operating element, in particular the steering unit, is attached to a fixed support structure and, for example, a body structure in a linearly displaceable manner. The receiving structure can then be moved linearly in particular (only) together with the operating element, in particular the steering unit.

In particular, the device, in particular the operating device, is designed such that a maximum current of the braking device during operation is less than 20 A and preferably less than 15 A and particularly preferably less than 10 A or even less than 5 A. Such a maximum current is in particular related to a supply voltage of 12 V for generating a braking torque of 35 Newton meters.

It is possible that the drive device can be operated as an electric generator. In particular, the generator is driven by the movement of the transmission element or control element driven. In particular, the movement is braked by the generator operation (in addition to the braking device). In this way, the braking effect can be increased in a targeted manner if required. In particular, the additional braking effect is taken into account when controlling the braking device. The electrical energy generated in generator operation can be used in particular to supply the braking device and/or the drive device. The generated electrical energy can be made available directly to the braking device. Additionally, or alternatively, an energy storage device and, for example, a battery can be provided.

The operating device presented here can be designed for steering or for operating other functions of a vehicle (e.g. rotary actuator with active adjustment by the motor) or other machines or devices (medical devices, computers, game controllers).

It is possible and advantageous for the device or operating device to be designed as a joystick. The transmission element or operating element is then preferably designed as a (pivotable) operating lever. In particular, the operating lever can be pivoted about at least two axes (X-axis, Y-axis). In particular, at least one actuator device is provided for each pivot axis. In particular, an axial flux motor is provided.

The operating device, in particular the joystick, can provide a steering input device for specifying a steering command according to the steer-by-wire concept (e.g. instead of a steering wheel). The operating device, in particular the joystick, can be provided for operating a simulator, a computer, a vehicle and/or a machine, such as a crane or excavator or an attachment of an (agricultural) vehicle. In the context of the present invention, a vehicle is also understood to mean a watercraft or an aircraft or a (remote-controlled) drone. The operating device, in particular the joystick, can serve as the throttle and/or brake lever of a vehicle.

In an advantageous embodiment, the device can be designed as a door device. The door device comprises in particular at least one door support structure and at least one door unit pivotably mounted on the door support structure. The movement of the door unit during opening and/or closing can be specifically dampened by means of the braking device.

The door unit can be actively moved to open and/or close by means of the drive device. Due to the common mounting structure of the present invention, the actuator device is particularly compact and can therefore be housed in the door frame or door post so that it is not visible from the outside.

The transmission element is in particular operatively connected to the door support structure and/or the door unit so that it can be moved by moving the door unit and/or so that it can actively move the door unit at least in sections. The braking device serves in particular to generate a braking torque which acts on the transmission element and thus also on the door unit. The drive device serves in particular to generate a torque which acts on the transmission element and thus also on the door unit. The door device can be designed as a building door or a vehicle door. The applicant reserves the right to claim a device designed as a door device.

The device presented here can also be designed as another type of device and, for example, as a brake-by-wire actuator, seat adjustment and/or locking device.

In an advantageous embodiment, the device can be designed as a body support mechanism for mechanically supporting a human or animal body. The body support mechanism is in particular a prosthesis and/or an exoskeleton device.

Within the scope of the present invention, a prosthesis is also understood to mean an orthosis. Due to the common support structure of the present invention, the body support mechanism is particularly compact and light, so that wearing comfort is improved.

The transmission element is in particular operatively connected to the human or animal body in such a way that it can be moved by the body using muscle power and/or that it can actively move the body at least in sections. The braking device serves in particular to generate a braking torque that acts on the transmission element and thus also on the body. The drive device serves in particular to generate a torque that acts on the transmission element and thus also on the body. For example, the prosthesis can be or partially replace an artificial body joint (knee, hip, foot, finger, elbow, shoulder joint, etc.) and/or body limb (arm, leg, foot, finger, etc.). The exoskeleton device serves in particular to actively support the muscle power of the body and to brake or dampen a movement of the body.

The exoskeleton device can be used, for example, as an industrial assembly aid. The body support mechanism preferably comprises at least one joint device with at least two joint units. In particular, the transmission element is mechanically coupled to at least one of the joint units. In particular, at least one actuator device is provided for each joint device. The applicant reserves the right to claim a device designed as a body support mechanism.

The receiving structure can be made up of several parts or one part. In particular, the receiving structure surrounds the drive device and/or the braking device and preferably also at least partially (predominantly) the shaft device.

The drive device and/or the braking device are each supported on the receiving structure in particular with respect to the torque or braking torque which they provide during operation.

In particular, the device comprises at least one holding structure. In particular, the drive torque or braking torque can be supported on the holding structure. The holding structure can be part of a console or a vehicle body or can be attached to it in a rotationally fixed manner (in particular in the context of an embodiment as an operating device).

The support structure can be attached to a human or animal body in a rotationally fixed manner (in particular in the context of a design as a body support mechanism). The support structure can also be attached to a building in a rotationally fixed manner (in particular in the context of a design as a door device).

The device can comprise at least one contacting device, which serves to electrically connect a component arranged on the transmission element to a component arranged outside the transmission element. The contacting device can, for example, comprise a coil spring device with at least one coil spring and/or a sliding contact device with at least one sliding contact. In particular, the contacting device enables power and/or signal transmission while the transmission element moves and preferably rotates. The contacting device is particularly advantageous if the device is designed as an operating device or steering input device and the transmission element is designed as an operating element or as a steering unit. It is possible for the contacting device to also serve to electrically connect the actuator device and/or the sensor device to a device for energy supply and/or control.

The rotationally fixed connection is in particular force-locking and/or positively and/or materially bonded. The one-piece connection is in particular materially bonded and preferably made of one piece or a continuous material.

However, a materially bonded connection made of different materials is also possible, e.g. a welded or adhesive connection.

The coil device of the braking device and/or the motor coil of the drive device are in particular attached to the stationary component. The stationary component is either the receiving structure or the shaft device. However, it is also possible that the coil device and/or the motor coil are attached to the component that rotates relative to the stationary component. In this case, for example, coil springs and/or sliding contacts or the like are provided for contacting.

In all embodiments, it is preferred that the magnetorheological medium comprises magnetorheological particles and gas as a filling medium. In particular, the magnetorheological particles are absorbed in air. In particular, the magnetorheological medium is designed as a magnetizable powder. It is also possible for the magnetorheological medium to comprise magnetorheological particles and a carrier liquid, such as oil, water or alcohol or the like. The medium can comprise liquid and/or solid additives (e.g. a graphite additive, molybdenum compounds, etc.).

It is particularly preferred that the magnetorheological particles (each) consist predominantly of carbonyl iron powder or its derivatives. Other magnetorheologically responsive particles are also possible. The magnetorheological particles can have coatings to protect against abrasion and/or corrosion and/or additional components to make the magnetorheological particles more durable, more abrasion-resistant and/or more slippery during operation. The maximum achievable speed at which the wheels of a vehicle are turned by the Road Wheel Actuator (“RWA”) depends on various external influences, e.g. the temperature of the RWA servomotors and/or the outside temperature, increased friction of the road wheels, for example due to insufficient tire pressure, material wear, etc. In order for the steering control device to be moved synchronously with the RWA servomotors, the mobility of the steering control device may have to be braked more strongly using the FEA in order to adapt the mobility of the steering control device to the achievable speed of the RWA.

If the interior temperature of the vehicle is high, for example due to sunlight while parking, this affects the performance of electric motors, since the torque that can be applied by electric motors is highly temperature-dependent. FFAs with magnetorheological brakes can reliably generate a high braking torque even at high temperatures and are therefore better suited for use at high temperatures.

Further advantages and features of the present invention will become apparent from the embodiments which are explained below with reference to the accompanying figures.

Shown here:

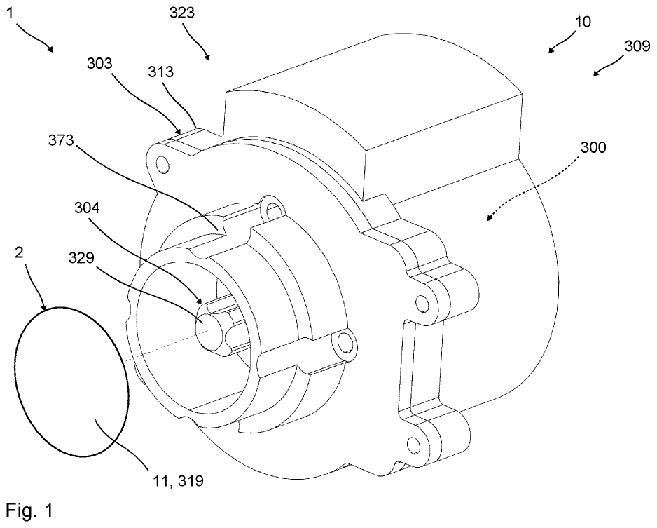

FIG. 1 is a purely schematic representation of a device according to the invention in a 8 perspective view;

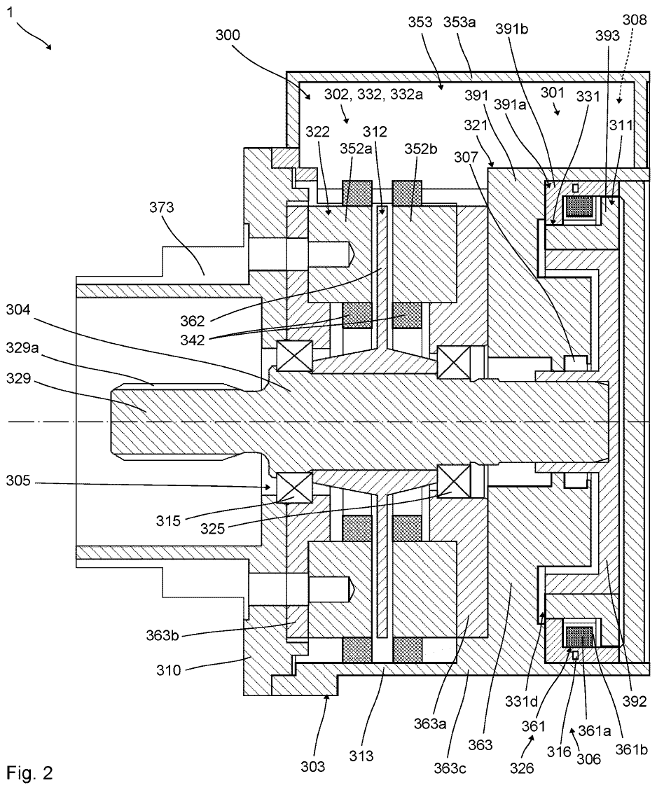

FIG. 2 is a purely schematic representation of a device in a sectional side view;

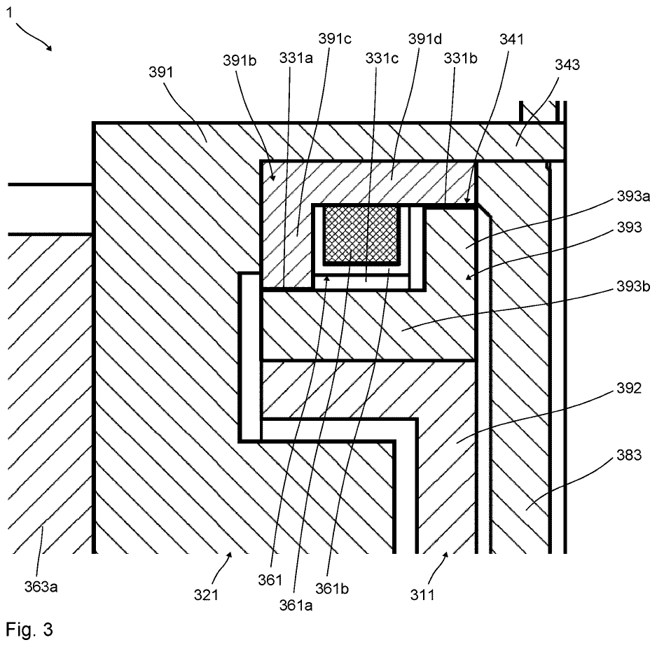

FIG. 3 is a detailed view of the device according to FIG. 2;

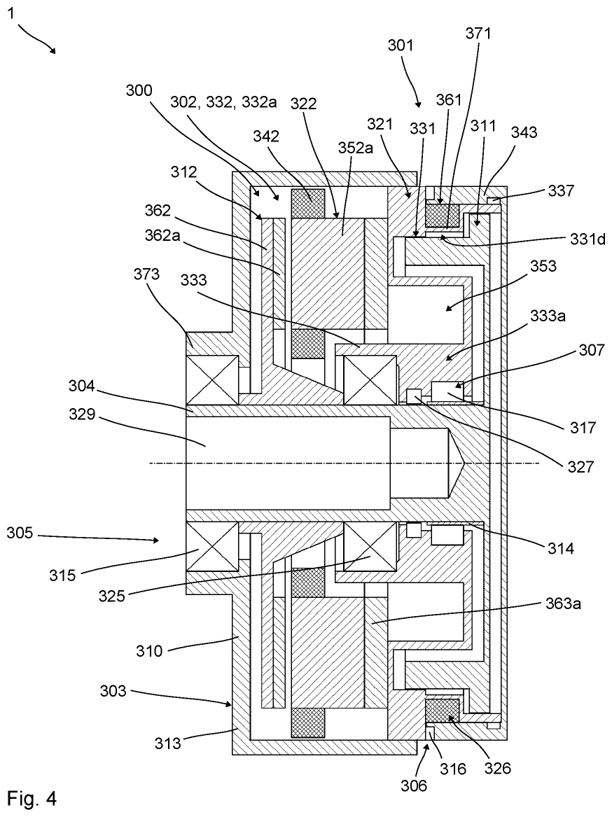

FIG. 4 is a purely schematic representation of another device in a sectional side view;

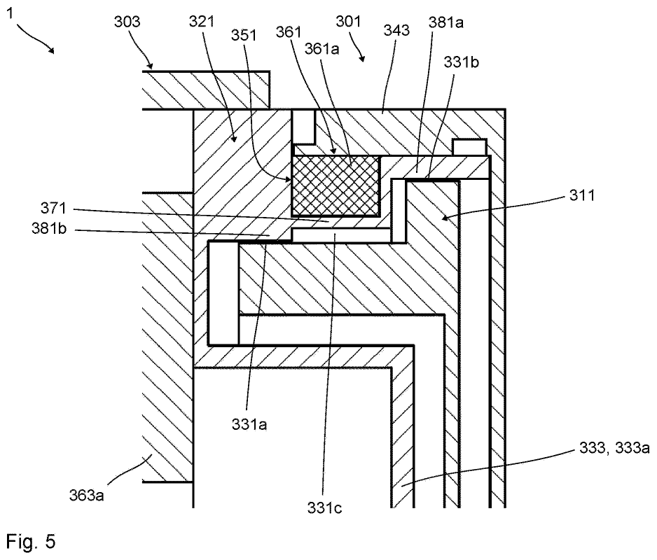

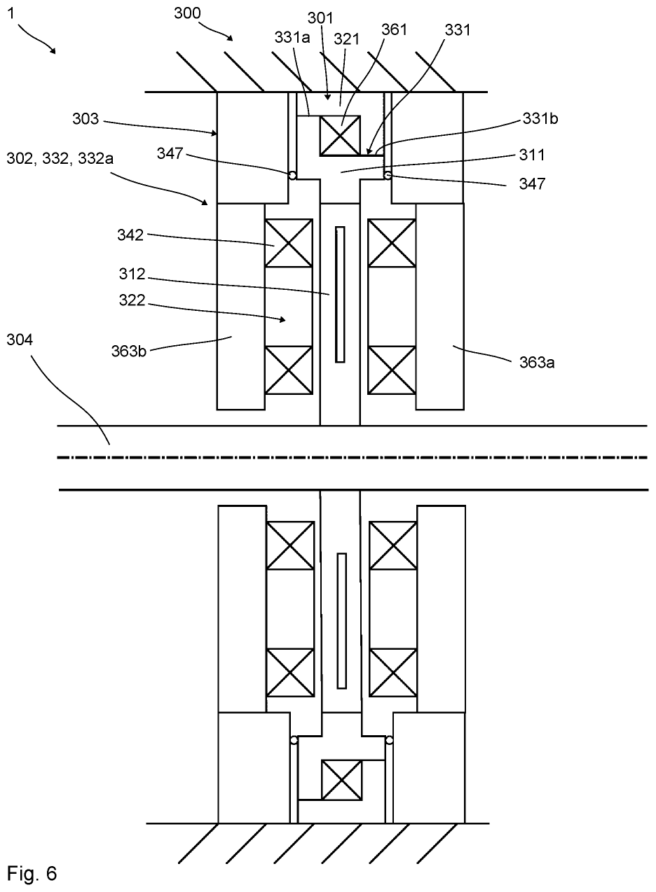

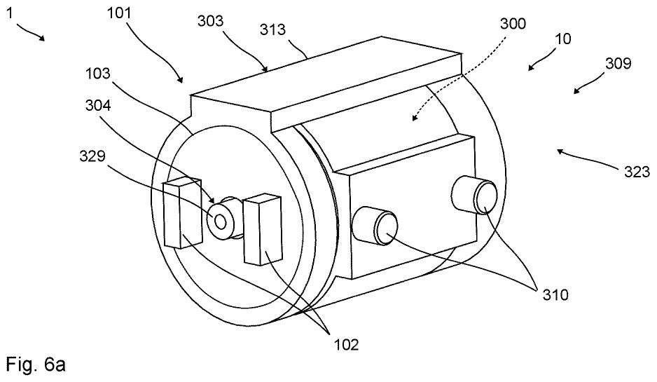

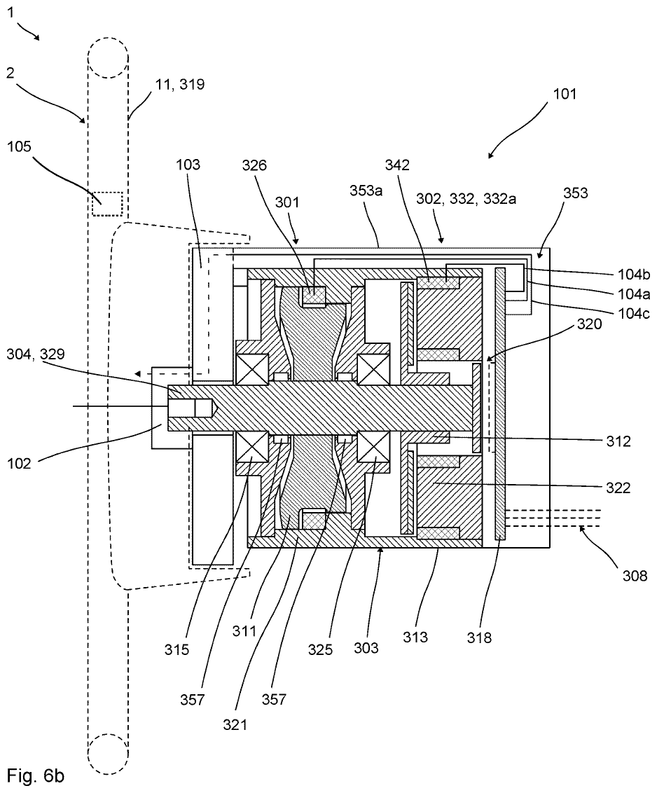

FIG. 5 is a detailed view of the device according to FIG. 4; 17 FIG. 6 is a purely schematic representation of another device in a sectional side view;

FIG. 6a is a purely schematic representation of a device in a perspective view;

FIG. 6b shows the device according to FIG. 6a in a sectioned side view;

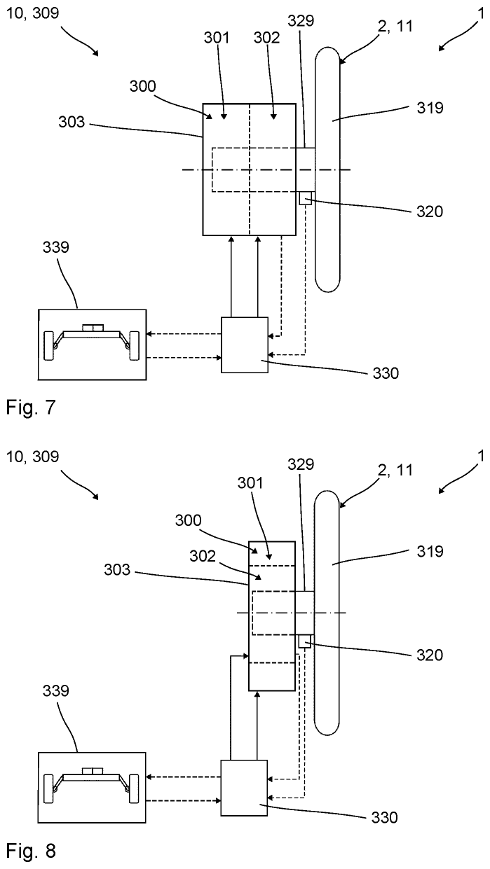

FIGS. 7-9 show highly schematic representations of each device in a sectional side view and its wiring;

FIGS. 10-11 show further purely schematic representations of one device in a sectional side view;

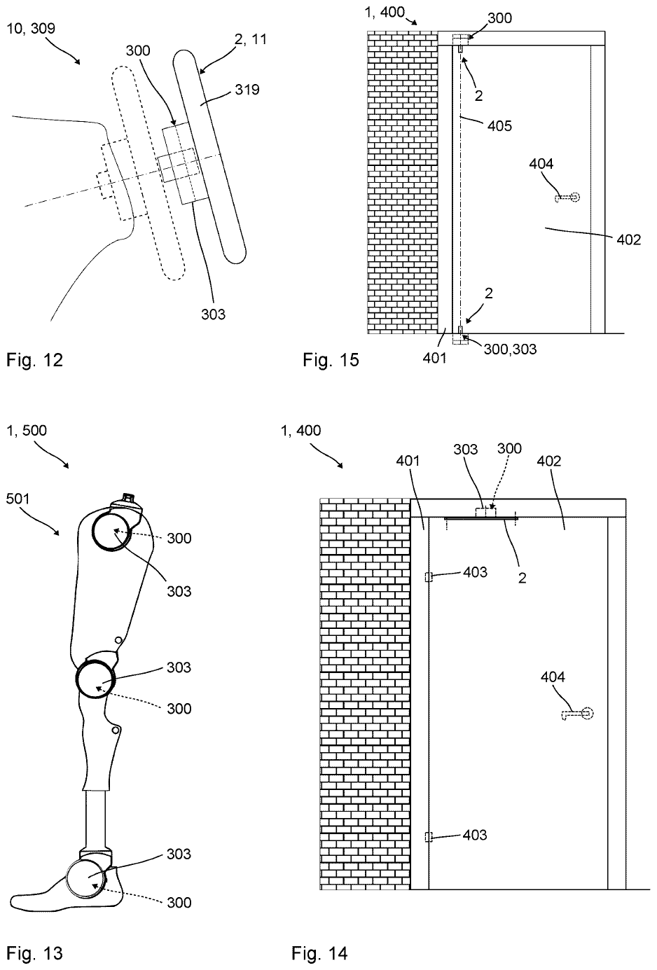

FIG. 12 is a purely schematic representation of a device in a side view;

FIG. 13 is a purely schematic representation of a body support mechanics formed from contraption;

FIG. 14 is a purely schematic representation of a door device designed device; and

FIG. 15 is a purely schematic representation of a device designed as a door mechanism.

FIGS. 1 to 3 show a device 1 according to the invention with an actuator device 300 for the targeted influencing of the mobility of a transmission element 2. The actuator device 300 comprises a drive device 302 with a first and a second drive component 312, 322 and a braking device with a first and a second braking component 311, 321. The dimensions of the components and in particular the wall thicknesses are shown schematically here and also in the other figures, so that a particularly clear and understandable presentation is possible.

This allows the transmission element 2 to be actively moved and specifically braked and to be subjected to haptic feedback. The braking device 301 and the drive device 302 are arranged adjacent to one another on a common receiving structure 303, which is designed here, for example, as a housing device 313.

The drive device 302 and the brake device 301 are arranged axially one behind the other on a shaft device 304. The shaft device 304 is connected in a rotationally fixed manner to the first drive component 312 and the first brake component 311. The second drive component 322 and the second brake component 321 are connected in a rotationally fixed manner to the receiving structure 303.

The shaft device 304 is rotatably mounted on the receiving structure 303 by means of a bearing device 305 with two bearing points 315, 325. The bearing points 315, 325 are designed here, for example, as rolling bearings or plain bearings. The receiving structure 303 here comprises two fastening plates 363a, 363b, on which the bearing points 315, 325 of the bearing device 305 for the shaft device 304 are supported.

The drive device 302 and the braking device 301 act directly on the shaft device 304 without an intermediate gear. The shaft device 304 is also directly connected to the control element 11 without an intermediate gear.

The common mounting structure 303 connects the drive device 302 and the braking device 301 to form a pre-assembly assembly 323. This can be handled as a single unit, for example, during vehicle assembly. For particularly straightforward assembly, the mounting structure 303 has, for example, an adapter 373 for connection to the vehicle's support structure. By being attached to the vehicle's support structure, the mounting structure 303 provides a torque support 310 for the drive device 302 and the braking device 301.

The device 1 shown here can be designed, for example, as an operating device 10. The transmission element 2 is then an operating element 11. For example, the operating device 10 is designed as a steering input device 309 for specifying a steering command according to the steer-by-wire concept.

For this purpose, the operating element 11 can be designed as a steering unit 319 and, for example, as a steering wheel. The shaft device 304 is then designed as a steering shaft 329. The steering shaft 329 can be coupled to the steering unit 319 in a rotationally fixed manner via a pin 329a.

The functioning of the steering input device 109 is described in more detail with reference to FIGS. 7 and 8.

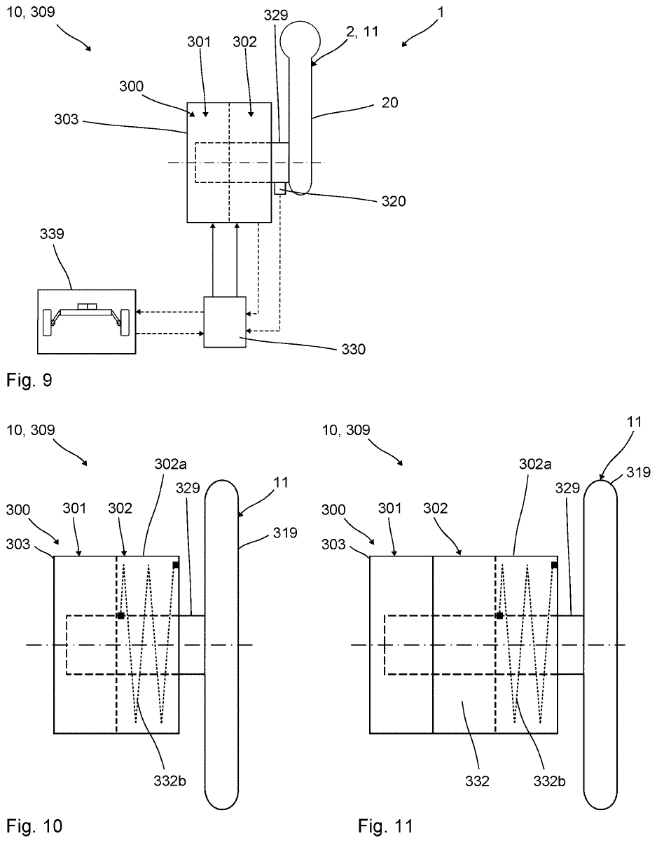

The operating device 10 can also be designed as a different type of operating device 10. For example, the operating element 11 is then a rotary knob or the like. In addition, the device 1 shown here can also be designed as described with reference to FIGS. 9 and 10.

The drive device 302 here comprises an electric motor 332 designed as an axial flux motor 332a. For this purpose, the second (fixed) drive component 322 has several core parts 352a, 352b, on each of which a motor coil 342 is wound. The first (rotatable) drive component 312 comprises a rotor designed as a disk part 362. Magnets (not shown here) are arranged on the disk part 362.

The disk part 362 extends between the core parts 352a on the left side and the core parts 352b on the right side. The core parts 352a, 352b on one side are each grouped in a ring shape. The core parts 352a, 352b are attached to the receiving structure 303 in a rotationally fixed manner via the fastening plates 363a, 363b. A circumferential (effective) gap 331 runs between the brake components 311, 321, in which a magnetorheological medium 331d is arranged. The gap 331 here comprises two gap sections 331a, 331b, which differ in their minimum and maximum diameters. A connecting gap 331c extends between the two gap sections 331a, 331b, so that a circumferential and continuous receiving space for the medium 331d is created. The magnetorheological braking effect is essentially provided in the gap sections 331a, 331b.

The gap sections 331a, 331b are not of the same diameter and are arranged in steps, for example. This makes installation much easier.

The brake component 321 here comprises a base section 391 and an outer magnetic flux flange 391b. The base section 391 here has a receiving space 391a for an electrical coil device 361 that is open axially outwards. The receiving space 391a is closed radially outwards by a cover section 343, which is here connected in one piece to the base section 391. The coil device 361 comprises a winding 361a arranged on a coil holder 361b. This can be used to generate an adjustable magnetic field that influences the medium 331d in such a way that the desired braking effect is generated.

The outer magnetic flux flange 391b is arranged both axially and radially between the coil assembly 361 and the base portion 391. The outer magnetic flux flange 391b has two L-shaped legs 391c, 391d. The legs 391c, 391d each radially delimit a gap portion 331a, 331b.

The other brake component 311 here comprises a rotor section 392 and an inner magnetic flux flange 393 with two legs 393a, 393b. The legs 393a, 393b each radially delimit a gap section 331a, 331b. The rotor section 392 and the inner magnetic flux flange 393 are formed separately here.

The magnetic flux flange 393 has a significantly higher magnetic conductivity than the rotor section 392. For example, the rotor section 392 here is made of a magnetically non-conductive material.

The gap sections 331a, 331b here have a gap height that varies in the circumferential direction. For this purpose, for example, the inner magnetic flux flange 393 and/or the outer magnetic flux flange 391b are equipped with a star contour 341 in the area of the gap sections 331a, 331b.

The device 1 can be equipped with a fault protection device 306, which specifically brakes the transmission element 2 in the event of a fault, so that, for example, the steering unit 319 is neither blocked nor can be moved without resistance. The fault protection device 306 comprises a permanent magnet device 316, which is arranged, for example, in the brake component 321 and in particular in the outer magnetic flux flange 391b.

The permanent magnet device 316 influences the medium 331d with its magnetic field in such a way that it brakes the mobility of the brake components 311, 321. In order to cancel this braking effect in normal operation, the magnetic field of the permanent magnet device 316 is specifically canceled by an electrical coil device 326. The coil device 326 is provided here by the coil device 361. However, a separate coil device 326 can also be provided. Other fault protection devices 306 are also possible (e.g. battery for generating an emergency braking torque with the coil 361 of the brake device 301, additional coil, etc.).

The motor coils 342 and the coil device 361 and, if required, also the coil device 326 of the emergency protection 306 are supplied or controlled via an electrical connection 308 (not shown in detail). The electrical connection 308 runs here via the receiving structure 303.

The advantage is that the coils 342, 361 can be connected easily without having to route cables through the shaft device 304. With a fixed shaft device 304, this is of course also possible in another way.

The receiving structure 303 or the housing device 313 here has a housing part 353a with an electronics compartment 353. For example, the electronics for controlling the actuator device 300 are housed there. The electronics compartment 353 could also be referred to as an electronics receiving compartment. The electrical connection 308 can preferably also run through the electronics compartment 353. A sensor device (not shown here) can also be housed there. An axial rear side is closed here by a housing cover 383.

The receiving structure 303 here comprises a separating web 363, which enables the drive device 302 to be separated from the braking device 301. The separating web 363 here merges in one piece into an outer housing wall 363c of the receiving structure 303. For example, the separating web 363 seals the gap 331 from the drive device 302. For a particularly reliable seal, a sealing device 307 is arranged here between the separating web 363 and the rotor section 392. The separating web 363 can also serve for magnetic shielding.

FIGS. 4 and 5 show a variant of the device 1. The brake component 311 is connected in one piece to the shaft device and is designed, for example, as a turned part made of a continuous material. The fixed brake component 321 is also designed as a turned part.

The brake component 321 here provides a receiving space 351 for the winding 361a of the electrical coil device 361. The receiving space 351 is closed radially outward by a cover section 343 of the receiving structure 303, which is part of the receiving structure 303. A bottom wall 371 runs between the receiving space 351 and the gap 331 and in particular the connecting gap 331c. The bottom wall 371 has a thickness which is less than a maximum height of the gap running below the bottom wall 371.

The brake component 321 has two effective gap walls 381a, 381b in the area of the receiving space 351, which are each arranged axially next to the bottom wall 371. In this case, one effective gap wall 381b extends further radially inward than the bottom wall 371 and than the other effective gap wall 381b. The bottom wall 371, however, extends further radially inward than the effective gap wall 381b.

The bottom wall 371 and the effective gap walls 381a, 381b are integrally connected to a partial section 333 of the receiving structure 303. The shaft device 304 is mounted on the partial section 333. The fixed or integral connection of the receiving structure 303 to the brake component 321 provides an integral structural component 333a. The structural component 333a supports the magnetorheologically active components of the brake component 321 and simultaneously provides the receptacle for a bearing point 325 for the shaft device 304.

In the electric motor 332 shown here, core parts 352a and motor coils 342 are arranged only on one axial side of the disk part 362. Magnets 362a are arranged between the disk part 362 and the core parts 352a.

A fastening plate 363a is arranged between the brake component 321 and the core parts 352a. This serves, for example, to fasten the core parts 352a and/or the brake component 321 to the receiving structure 303 and, if required, can also provide shielding of the brake device 301 from the drive device 302 (in particular with regard to the magnetic fields).

To seal the gap 331, the sealing device 307 is here equipped with three seals 317, 327, 337. Basically contacting or non-contacting seals (e.g. magnetic seal), sealing medium seal (ferrofluid seal, sealing grease seal) etc. are possible.

The seal 317 is designed, for example, as a contact seal between the cover section 343 and the brake component 321.

A running sleeve can be arranged between the seal 317 and the shaft device 304, the material of which is harder than the base material of the shaft device 304.

The seal 327 is provided, for example, as a magnetic seal for capturing particles of the medium 331d and, for example, carbonyl iron powder particles. This prevents the particles from entering the bearing location 325 behind it, which could lead to bearing damage. A further seal 337 is formed between the cover section 343 and the brake component 321 in the vicinity of the receiving space 351.

In the variant shown here, the receiving structure 303 also has an electronics compartment 353. The shaft device 304 is designed as a hollow shaft, so that space is available for installing sensors (for example a torsion bar for a torque sensor) or other components. In the version shown here, a permanent magnet device 316 can also be provided for a fault protection device 306.

FIG. 6 shows a variant of the device 1 in which the drive device 302 and the braking device 301 are arranged coaxially. The drive device 302 is located radially inward and the braking device 301 is located radially outward, resulting in a radially nested arrangement. The drive device 302 here comprises an electric motor 332 designed as an axial flux motor 332.

In the coaxial arrangement shown here, the brake component 311 is non-rotatably connected to the drive component 312.

The drive components 312, 322 are arranged axially adjacent to one another. The brake components 311, 321 are arranged coaxially. The brake component 311 connected to the drive component 312 is arranged radially inward here. The brake component 321 and the coil device 361 attached to it are located radially outward.

In the radial direction between the two brake components 311, 321 is the (active) gap 331 with two gap sections 331a, 331b. The radially outer brake component 321 is non-rotatably supported on the receiving structure 303. The drive component 322 is also non-rotatably connected to the receiving structure 303. The drive device 302 is sealed here by two seals 347 against the medium 331d (not shown here).

FIGS. 6a and 6b show the device 1 with a contacting device 101, which serves to electrically connect the steering unit 319 to a vehicle. In addition, an example of contacting of the actuator device 300 can also be clearly seen here. The contacting device 101 and the contacting are also suitable for integration into the other devices 1 shown here.

In FIG. 6a, the torque support 310 can be clearly seen, which here comprises two bolt-like extensions.

The braking device 301 and the drive device 302 are arranged axially one behind the other on the common receiving structure 303. However, a radial arrangement is also possible.

The drive device 302 is designed here as an axial flux motor 332a. The number and arrangement of the motor coils 342 is shown schematically here for better clarity.

The receiving structure 303 encloses here with a housing part 353a an electronics compartment 353 in which the electrical connection 308 and the electronics for controlling the actuator device 300 and sensor device 320 are housed or accommodated. For this purpose, a circuit board 318 is arranged axially behind the drive device 302.

The electrical connection 308 (shown in dashed lines) is contacted on the circuit board 318.

A line 104a for supplying energy or controlling the braking device 301 and a line 104b for supplying energy or controlling the drive device 302 (in particular to its coils) extend from the circuit board 318. In addition, a line 104c extends to the contacting device 101. In addition or as an alternative to the variant shown here, the lines can run at least partially through the (hollow) shaft device 304. For better clarity, the lines 104a-c are shown purely schematically by a solid line. Each of the three lines 104a-c can comprise one or more conductors (wires) that are insulated from one another, as is also the case in the exemplary embodiment. Additional lines are also possible as required.

A part of the sensor device 320 is located on the circuit board 318. Another part of the sensor device 320, for example a magnetic ring or the like, is arranged in a rotationally fixed manner on the shaft device 304. The sensor device 320 here comprises, for example, a Hall sensor or inductive sensor.

Electrical or electronic components 105 of the steering unit 319 can be connected to the vehicle or its on-board electronics via the contacting device 101. When steering, the components rotate together with the steering unit 319.

For example, these can be control elements and/or an airbag integrated into the steering wheel. Such control elements can be used to operate a navigation system, an entertainment device and/or vehicle functions, for example.

The contacting device 101 comprises here purely by way of example two contacting elements 102, which rotate together with the steering unit 319. For example, the contacting elements 102 are designed as plugs or the like, so that the plug connections can be made during assembly of the steering unit 319. The contacting elements 102 are connected to the circuit board 318 via the line 104c.

The contacting device 101 also comprises a coil spring device 103 with at least one coil spring. The coil spring device 103 enables the contacting elements 102 to rotate with the steering unit 319 without the cables 104 connected to it breaking off. When the steering unit 319 is rotated, the coil springs are wound up or unwound. The length of the coil springs is matched to the desired rotation of the steering unit 319. The rotation of the steering unit 319 can be limited by means of at least one end stop (not shown here).

The coil spring device 103 offers a particularly reliable and low-maintenance contact. In addition to or as an alternative to the coil spring device 103, a sliding contact device with at least one sliding contact can also be provided.

FIG. 6b shows a particularly advantageous variant of the actuator device 300, which can also be used in the other embodiments of the device 1 presented here. As a result, both the braking device 301 and the drive device 302 can be reliably mounted on the shaft device 304 with only two bearing points 315, 325.

The drive device 302 is connected to the brake device 301 by means of the common receiving structure 303, so that the drive device 302 can use the bearing points 315, 325 of the brake device 301. A further advantage is that the sealing of the effective gap 331 here is provided with two sealing arrangements 357 can be used. The sealing arrangements 357 are shown in simplified form in FIGS. 6a and 6b and can each have several seals, as was explained, for example, in connection with the explanations for FIGS. 4 and 5.

Overall, this results in a particularly compact, lightweight and at the same time very powerful actuator device 300.

The braking device 301 shown in FIGS. 6a and 6b can have a permanent magnet device—omitted for reasons of clarity—as was explained, for example, in connection with the exemplary embodiments shown in FIGS. 2-5.

FIGS. 7 and 8 show the basic structure of a vehicle with an operating device 10 designed as a steering control device 309. FIG. 7 shows an axial arrangement of drive device 302 and braking device 301. FIG. 8 shows a coaxial structure of drive device 302 and braking device 301.

The operating device 10 is connected to a steering device 339 of the vehicle without a mechanical connection and in particular purely electrically or electronically. The steering device 339 can adjust the steered wheels of the vehicle and thereby convert the steering movement carried out with the steering unit 319 into a vehicle movement. The position or the movements and/or the torque and/or the speed of the steering unit 319 are detected here with a sensor device 320. For example, a rotation angle sensor or a torque sensor or a combination of both is provided.

The sensor device 320 provides its information to a control device 330. Additionally or alternatively, further sensor 8 means may be provided in the braking device 301 and/or in the drive device 302, which also provide their information to the control device 330.

The steering device 339 receives the target specifications from the control device 330. In addition, the steering device 339 can transmit requirements for the torque for the haptic feedback. The control device 330 then controls the braking device 301 and the drive device 302 so that haptic feedback can be perceived on the steering unit 319, which corresponds, for example, to that of a conventional mechanical steering system.

In FIG. 9, the steering input device 309 is shown in a variant designed as a joystick 2. The other variants of the device 1 described here can also be designed as a joystick 20. In the variant shown, the joystick 20 is designed as a one-dimensional joystick 20, which could also be referred to as an operating lever. It is conceivable and possible to provide a multi-dimensional joystick 20 with more than one degree of freedom, e.g. two (rotational) degrees of freedom. Then, in particular, at least one actuator device 300 is assigned to each of the degrees of freedom for exerting haptic feedback on the operating lever.

FIG. 10 shows the steering input device 309 with a drive device 302, which is provided here by a force storage device 302a with a spring 332b. The force storage device 302a is charged by the movements during steering. The steering unit 319 can thus be moved back from a deflected position to a rest position. The characteristic curve of the spring 332b can be adjusted using the braking device 301. This means that braking can take place in one direction of movement and braking and independent movement can take place in the other direction.

In FIG. 11, a variant is shown in which the drive device 302 has both a force storage device 302a and an electric motor 332. Thus, the energy storage device 302a supports the electric motor 332. This allows braking and independent movement in both directions.

FIG. 12 shows the steering input device 309 with a linearly displaceable steering unit 319. The receiving structure 303 and thus also the actuator device 300 housed therein are displaced linearly together with the steering unit 319. Here it can also be clearly seen that the receiving structure 303 and the actuator device 300 can be arranged directly on the steering unit 319 due to their particularly compact design and their low weight.

In the prior art, the force feedback actuator is usually installed at the end of the steering column that is opposite the steering wheel (i.e. where the universal joint to the wheels goes in conventional steering units). In the invention, the actuator device can be arranged so close to the steering wheel that the actuator device 300 or the receiving structure 303 can be seen from the interior of the vehicle.

Here, the support structure 303 is connected to the steering unit 319 in a rotationally fixed manner. When the steering wheel is adjusted lengthwise, the actuator device 300 moves with the steering wheel (as shown in dashed lines). By arranging it close to the steering wheel, torque transmission over the entire steering column, i.e. from the steering wheel via various sliding shafts to the force feedback actuator (as in the prior art), can be dispensed with. Alternatively, the actuator device 300 can also be arranged at the opposite end of a conventional steering column.

The arrangement shown here is possible for all types of vehicles and also for control devices 10 for simulations/gaming. It is also very suitable for vehicles for at least partially autonomous driving. This is because larger axial adjustment ranges of more than 70 mm or 100 mm and e.g. 250 mm are often required. Removing the steering wheel is desired. Since the actuator device 300 described here requires particularly low currents (e.g. 3 amps in relation to the state of the art with 60 amps), no power cables with a large cross-section are required. In addition, heat dissipation is optimized here, since the actuator device 300 is not installed inside the dashboard, but is on the steering unit 319 with an exposed mounting structure 303.

FIG. 13 shows a device 1 designed as a body support mechanism 500. This is, for example, a (leg) prosthesis 501. The movement of the prosthesis 501 can be actively carried out or supported and also specifically braked using the actuator devices 300 housed in a receiving structure 303. The respective transmission elements 2 (not visible here) are operatively connected both to the body and to the actuator device 300.

FIG. 14 shows a device 1 designed as a door device 400.

The door device 400 here comprises a door support structure 401 attached to the building and a door unit 402 pivotably mounted on the door support structure 401 by means of hinges 403. The door unit 402 can be opened here with a door handle 404, with the actuator device 300 serving as support. A fully automatic door opening is also possible.

The transmission element 2 is operatively connected to the door support structure 401 and the door unit 402.

Preferably, the receiving structure 303 and the actuator device 300 are arranged in the door support structure 401 so that they are not visible from the outside.

The drive device 302 can have an electric motor 332 and/or a force storage device 302a. Opening and closing can thus be carried out by means of the electric motor 332. It is also possible for the (open) door unit 402 to be closed using the force storage device 302a (spring return). Both directions of movement (opening and closing) can be influenced by the braking device 301. (e.g. controlled closing of the door unit so that it does not hit the starting position.

In the invention presented here, the electric motor 332 and the braking device 301 are preferably located directly adjacent to one another and are preferably of integrated construction. The design torques for the electric motor 332 are, for example, 0-5 Nm; for the braking device 301, for example, 0-20 Nm or 0-25 Nm or 0-35 Nm.

FIG. 15 shows an alternative embodiment of the device 1 designed as a door device 400. The door device 400 here comprises a door support structure 401 attached to the building and a door unit 402 pivotally mounted on the door support structure 401 by means of a transmission element 2.

The door unit 402 can be opened here with an optional door handle 404, with the actuator devices 300 serving to assist. Fully automatic door opening is also possible here.

The receiving structure 303 and the actuator devices 300 are preferably arranged in the door support structure 401 or in the floor structure (not separately designated) so that they are not visible from the outside. The axis of rotation of the actuator device 300 and the axis of rotation 405 of the door unit are arranged coaxially in the exemplary embodiment. A gear device can be arranged between the actuator device and the transmission element 2, in which case a gear is advantageously provided which does not influence the coaxiality of the axis of rotation of the door device and the actuator device, for example a planetary gear. In the embodiment according to FIG. 15, however, a direct drive is provided, i.e. a gear is dispensed with.

In the embodiment according to FIG. 15, the door device can be pivoted from the basic position (closed state) in opposite directions so that a pivot angle of more than 180° can be achieved. In FIG. 15, an actuator device 300 is shown both in the area above the door unit 402, i.e. in the door frame, and in the area below the door unit 402. This means that the door device 400 has two actuator devices 300 here. However, this is not mandatory. Only one of the actuator devices 300 could also be provided, for example only in the door frame or only below the door unit 402.

Preferably, the drive device (the electric motor) is shorter in the axial direction than in diameter. In particular, the outer diameter of the drive device and/or the braking device is less than 125 mm, preferably less than 110 mm and particularly preferably less than 100 mm.

The motor coils 342 and/or the coil device 361 of the braking device 301 can be wound from a coil wire made of copper, aluminum, etc. The cross-sectional shape of the coil wire can be round or polygonal, e.g. rectangular or square or hexagonal or octagonal.

Based on a 12 V supply voltage for generating 35 Nm braking torque, the maximum current of the braking device 301 during operation is advantageously less than 20 A (amperes), preferably less than 15 A, particularly preferably less than 10 A, e.g. less than 5 A.

The total current for operating the electric motor 332 and the MR brake when the motor and the braking device 301 are operated together is advantageously less than 20 A, preferably less than 15 A, particularly preferably less than 10 A, e.g. less than 5 A, based on a supply voltage of 12 V.

Lower power consumption can reduce the component costs for the electronics, e.g. power filtering, MOSFETs and control units. For example, the control for adjusting the steering wheel position can be used to control the actuator device 300 if necessary. The drive device 302 and the braking device 301 can preferably be controlled simultaneously in order to achieve a total torque (from the motor torque and the braking torque of the MR brake). It is also possible to blend the motor torque and braking torque (e.g., increasing the motor torque and reducing the braking torque and vice versa). The maximum total torque of the FFA can be achieved by applying maximum current to the motor and the MR brake.

The maximum total torque can, for example, be in a range of higher than 20 Nm, e.g., 25 Nm or 35 Nm or more.

For example, the combination of magnetorheological brake and axial flux motor shown here requires approximately half to a third less construction volume, less than half the weight and up to a factor of 10 less electrical power than a conventional steer-by-wire steering system. This means that the invention can also be installed in special or difficult positions in the vehicle. In addition, the range of electric vehicles can be improved.

List of Reference Symbols:

| | |
|---|---|
| 1 | Device |
| 2 | Transmission Element |
| 10 | Operating Device |
| 11 | Control Element |
| 20 | Joystick |
| 101 | Contacting Device |
| 102 | Contacting Element |
| 103 | Coil Spring Device |
| 104 | Line |
| 105 | Component |
| 300 | Actuator Device |
| 301 | Braking Device |
| 302 | Drive Device |
| 302a | Energy Storage Device |
| 303 | Receiving Structure |
| 304 | Shaft Device |
| 305 | Bearing Deivce |
| 306 | Fault Protection Device |
| 307 | Sealing Device |
| 308 | Connection |
| 309 | Steering Control Device |
| 310 | Torque Support |
| 311 | Brake Component |
| 312 | Drive Component |
| 313 | Housing Device |
| 314 | Barrel Sleeve |
| 315 | Bearing Point |
| 316 | Permanent Magnet |
| 317 | Seal |
| 318 | Printed Circuit Board |
| 319 | Steering Unit |
| 320 | Sensor Device |
| 321 | Brake Component |
| 322 | Drive Component |
| 323 | Pre-Assembly |
| 325 | Bearing Point |
| 326 | Coil Device |
| 327 | Seal |
| 329 | Steering Shaft |
| 329a | Pin |
| 330 | Control Device |
| 331 | Gap |
| 331a | Gap Section |
| 331b | Gap Section |
| 331c | Connection Gap |
| 331d | Medium |
| 332 | Electric Motor |
| 332a | Axial Flux Motor |
| 332b | Spring |
| 333 | Section |
| 333a | Structural Component |
| 337 | Seal |
| 339 | Steering Device |
| 341 | Star Contour |
| 342 | Motor Coil |
| 343 | Cover Section |
| 347 | Seal |
| 351 | Receiving Space |
| 352a | Core Part |
| 352b | Core Part |
| 353 | Electronics Compartment |
| 353a | Housing Part |
| 357 | Seal Arrangement |
| 361 | Coil Device |
| 361a | Winding |
| 361b | Coil Holder |
| 362 | Disk Part |
| 362a | Magnet |
| 363 | Separator Device |
| 363a | Fastening Plate |
| 363b | Fastening Plate |
| 363c | Housing Wall |
| 371 | Bottom Wall |
| 373 | Adapter |
| 381a | Effective Gap Wall |
| 381b | Effective Gap Wall |
| 383 | Housing Cover |
| 391 | Base Section |
| 391a | Receiving Space |
| 391b | Magnetic Flux Flange |
| 391c | Leg |
| 391d | Leg |
| 392 | Rotor Section |
| 393 | Magnetic Flux Flange |
| 393a | Leg |
| 393b | Leg |
| 400 | Door Device |
| 401 | Door Support Structure |
| 402 | Door Unit |
| 403 | Hinge |
| 404 | Door Handle |
| 405 | Rotation Axis |
| 500 | Body Support Mechanism |
| 501 | Prosthesis |

1-39. (canceled)

40. A device comprising:
at least one actuator for selectively influencing a mobility of a transmission element, said actuator having:
a magnetorheological brake for generating a braking torque acting on said transmission element, wherein the mobility of said transmission element can be selectively braked;
a drive for generating a torque acting on said transmission element, wherein said transmission element can be actively moved; and
said brake and said drive being arranged adjacent to one another on a common receiving structure.

41. The device according to claim 40, wherein said receiving structure comprises a housing, and said drive and said brake are housed within said housing.

42. The device according to claim 40, wherein said receiving structure connects said drive and said brake forming a pre-assembled assembly.

43. The device according to claim 40, wherein said drive and said brake are arranged axially one behind the other or at least partially coaxially with one another.

44. The device according to claim 40, further comprising:
at least one shaft;
said shaft and said receiving structure being configured to rotate relative to one another; and
a relative movement between said shaft and said receiving structure being configured to be driven by said drive and braked by said brake.

45. The device according to claim 44, wherein:
said shaft is coupled to said transmission element such that said shaft and said transmission element can be rotated together while said receiving structure is stationary; or
said receiving structure is coupled to said transmission element such that said receiving structure and said transmission element can be rotated together while said shaft is stationary.

46. The device according to claim 44, wherein said drive and said brake act on the shaft without an intermediate gear.

47. The device according to claim 44, wherein said shaft is connected to said transmission element without an intermediate gear; or said receiving structure is connected to said transmission element without an intermediate gear.

48. The device according to claim 44, wherein said drive has at least two drive components rotatable relative to one another and said brake has at least two brake components being rotatable relative to one another, and said shaft is rotationally fixed to one of said at least two drive components and to one of said at least two brake components.

49. The device according to claim 40, wherein said receiving structure is rotationally fixed to one of at least two drive components of said drive, said at least two drive components are rotatable relative to one another and to one of at least two brake components of said brake, and said at least two brake components are rotatable relative to one another.

50. The device according to claim 48, further comprising a bearing having at least two bearing points, said shaft and said receiving structure being rotatably mounted to one another via said bearing, and said drive components of said drive and said brake components of said brake being are mounted exclusively by said bearing.

51. The device according to claim 40, wherein an electrical connection of said drive and/or an electrical connection of said brake is made via said receiving structure.

52. The device according to claim 48, wherein said the drive component connected in a rotationally fixed manner to said shaft at least partially provides said brake component connected in a rotationally fixed manner to the shaft.

53. The device according to claim 45, wherein said drive component connected in a rotationally fixed manner to said receiving structure at least partially provides said brake component connected in a rotationally fixed manner to said receiving structure.

54. The device according to claim 40, wherein:
said drive has at least one electric motor or is at least one electric motor; and
said at least one electric motor is an axial flux motor or a bell-shaped armature motor.

55. The device according to claim 48, wherein at least one circumferential gap is formed between said brake components, and said at least one gap is at least partially filled with a magnetorheological medium.

56. The device according to claim 55, wherein said gap has a variable gap height in the circumferential direction.

57. The device according to claim 55, wherein said gap has at least two circumferential gap sections arranged at a distance from one another, and said gap sections have different minimum and/or maximum diameters.

58. The device according to claim 55, wherein one of said brake components has at least one receiving space for a winding of an electrical coil device; a bottom wall of said one of said brake component, which extends between said receiving space and said gap, has a thickness; and said thickness is less than a maximum height of said gap extending below said bottom wall.

59. The device according to claim 58, wherein:
said brake component having said receiving space has at least two effective gap walls;
said at least two gap walls are each axially next to the bottom wall;
one of said at least two effective gap walls extends further radially inward than said bottom wall; and
said bottom wall extends further radially inward than the other of said at least two effective gap walls.

60. The device according to claim 59, wherein said bottom wall and said at least two gap walls and a partial section of said receiving structure are integrally connected to one another.

61. The device according to claim 60, wherein said shaft is mounted on the partial section.

62. The device according to claim 58, wherein said receiving space is closed radially outwardly by a cover section of said receiving structure.

63. The device according to claim 48, wherein one of said at least two brake components has a base section with a receiving space open axially outward for receiving an electrical coil and at least one outer magnetic flux flange, and said outer magnetic flux flange is arranged both axially and radially between the coil device and the base section.

64. The device according to claim 63, wherein said outer magnetic flux flange has at least two legs, and each of said at least two legs radially outwardly delimits a gap section of the gap.

65. The device according to claim 48, wherein one of said at least two brake components has a rotor section and an inner magnetic flux flange with at least two legs, and each of said at least two legs radially delimits a gap section of the gap.

66. The device according to claim 65, wherein said rotor section and said inner magnetic flux flange are formed separately and connected to one another in a rotationally fixed manner, and said inner magnetic flux flange has a higher magnetic conductivity than said rotor section; or said rotor section and said inner magnetic flux flange are integrally connected to one another.

67. The device according to claim 40, wherein the brake has at least two brake components rotatable relative to one another, and said receiving structure and one of said at least two brake components are integrally connected to one another.

68. The device according to claim 40, wherein said drive and said brake share at least one of the following components: a shaft, a bearing for supporting at least two drive components rotatable relative to one another and at least two brake components rotatable relative to one another, a seal, a torque support, and an electrical connection.

69. The device according to claim 40, further comprising at least one fault protection device configured to apply a targeted torque to the mobility of said transmission element at least in the event of a failure of said brake and/or said drive, such that the transmission element is neither blocked nor can be moved without resistance.

70. The device according to claim 69, wherein said fault protection device comprises at least one permanent magnet having a magnetic field configured to brake the mobility of said braking components with a defined torque, and the magnetic field of said permanent magnet is configured to be reduced and/or increased during normal operation by an electrical coil.

71. The device according to claim 40, wherein a maximum braking torque of said brake is greater than a maximum torque of said drive.

72. The device according to claim 40, wherein the mobility of said transmission element is configured to be influenced by said brake such that haptically perceptible feedback can be generated.

73. The device according to claim 40, wherein the device is configured as an operating device with at least one movable operating element.

74. The device according to claim 40, wherein the device is configured as a steering input device for inputting a steering command according to the steer-by-wire concept, and said transmission element is configured as an operating element or said transmission element has an operating element.

75. The device according to claim 73, further comprising at least one shaft; and said receiving structure being mounted directly on said operating element, or said shaft being mounted directly on said operating element and having a length that is less than or equal to 2.5 times an axial extent of said receiving structure.

76. The device according to claim 73, wherein said the operating element is linearly displaceably attached to a fixed support structure and said receiving structure is linearly displaceable together with said operating element.

77. The device according to claim 40, wherein said device is configured as a door with at least one door support structure and with at least one door unit pivotably mounted on the door support structure.

78. The device according to claim 40, wherein the maximum current of the brake, based on a 12V supply voltage for generating 35 Nm of braking torque, is less than 20 A during operation.
